(19) United States
(12) Patent Application Publication
(10) Pub. No.: US 2010/0264004 A1
(43) Pub. Date: Oct. 21, 2010

(54) APPARATUS FOR MOUNTING AN ACCESSORY DEVICE TO A CIRCUIT BREAKER

(76) Inventors: Samir Rajauria, Agra (IN); Lars Pommerencke, Neumunster (DE); Dean Arthur Robarge, Southington, CT (US)

Correspondence Address: General Electric Company;GE Global Patent Operation, 2 Corporate Drive, Suite 648, Shelton, CT, 06484, US

(21) Appl. No.: 12/424,989

(22) Filed: Apr. 16, 2009

(51) Int. Cl. H01H 5/00

(52) U.S. Cl. 200/400

(57) ABSTRACT

An apparatus for connecting an accessory device to a circuit breaker to attenuate mechanical force generated by the accessory device includes a base having one or more projections configured to engage the circuit breaker to form a rigid connection to the circuit breaker, and one or more apertures configured for engagement with the accessory device to form a rigid connection to the accessory device.

### BACKGROUND

1. Field

The subject matter described herein relates generally to circuit breakers and, more particularly, to mounting accessory devices to circuit breakers.

2. Related Art

It is known in the art to provide molded case circuit breakers for electrical systems. The circuit breaker is operative to disengage the electrical system under certain operating conditions. The use of accessories such as, for exemplary purposes only, motor operators to allow the motor-assisted operation of electrical circuit breakers is well known. The motor operator allows the circuit breaker to be operated remotely and to be opened, closed or reset after tripping of the circuit breaker.

The motor operator is typically secured to the top of a circuit breaker housing. A lever within the motor operator mechanically interacts with a circuit breaker operating handle, which extends from the circuit breaker housing. The lever is operatively connected to a motor within the motor operator. The motor drives the lever, which, in turn, moves the operating handle to operate the circuit breaker. The operating handle is moved between “on”, “off”, and “reset” positions, depending on the rotational direction of the motor.

A plurality of buttons external to the motor operator controls electrical current to the motor. The rotational direction of the motor is changed depending on which of these buttons is selected by operating personnel. Thus, the operating personnel can select one button to place the operating handle in the “on” position, and another button to place the operating handle in the “off” or “reset” positions.

When the handle is moved to the “on” position, electrical contacts within the circuit breaker are brought into contact with each other, allowing electrical current to flow through the circuit breaker. When the handle is moved to the “off” position, the electrical contacts are separated, stopping the flow of electrical current through the circuit breaker. When the handle is moved to the “reset” position, an operating mechanism within the circuit breaker is reset, as is necessary after the operating mechanism has tripped in response to an overcurrent condition in the electrical circuit being protected by the circuit breaker.

Due to the mounting of the motor operator onto the case of the circuit breaker, the motor operator may generate large amounts of mechanical shock during operation, which may adversely effect the performance of the circuit breaker or accessory device internal to or peripheral to the circuit breaker. It would be desirable to mount accessories such as for example, motor operators, to a circuit breaker such that mechanical shock generated by the accessories is minimized.

### Brief Description of the Embodiments

In accordance with one exemplary embodiment, an apparatus for connecting an accessory device to a circuit breaker to attenuate mechanical force generated by the accessory device is described. The apparatus includes a base having one or more projections configured to engage the circuit breaker to form a rigid connection to the circuit breaker, and one or more apertures configured for engagement with the accessory device to form a rigid connection to the accessory device.

In accordance with another exemplary embodiment, an assembly for connecting an accessory device to a circuit breaker includes an accessory base plate and an apparatus. The apparatus has a base having one or more projections configured to engage the circuit breaker to form a rigid connection to the circuit breaker, and one or more apertures configured for engagement with the accessory base plate to form a rigid connection to the accessory base plate.

In accordance with still another exemplary embodiment, a circuit breaker assembly includes a circuit breaker, an accessory device, and an apparatus. The apparatus has a base having one or more projections configured to engage the circuit breaker to form a rigid connection to the circuit breaker, and one or more apertures configured for engagement with the accessory device to form a rigid connection to the accessory device.

In accordance with yet another exemplary embodiment, a method for attenuating mechanical force induced in a circuit breaker by an accessory device includes engaging the circuit breaker with an apparatus to form a rigid connection to the circuit breaker, and engaging the accessory device with the apparatus to form a rigid connection to the accessory device. The rigid connections to the circuit breaker and the accessory device operate to attenuate mechanical force generated by the accessory device.

### BRIEF DESCRIPTION OF THE DRAWINGS

The following detailed description is made with reference to the accompanying drawings, in which:

FIG. 1 is schematic exploded view of a circuit breaker and circuit breaker accessory;

FIGS. 2A through 2C are partial schematic illustrations of the circuit breaker and circuit breaker accessory of FIG. 1 in accordance with an exemplary embodiment;

FIG. 3A is a partial schematic illustration of a portion of the circuit breaker and circuit breaker accessory of FIG. 1 in accordance with an exemplary embodiment; and

FIG. 3B is a schematic illustration of a portion of the circuit breaker of FIG. 1 in accordance with an exemplary embodiment.

### DETAILED DESCRIPTION OF THE PREFERRED EMBODIMENTS

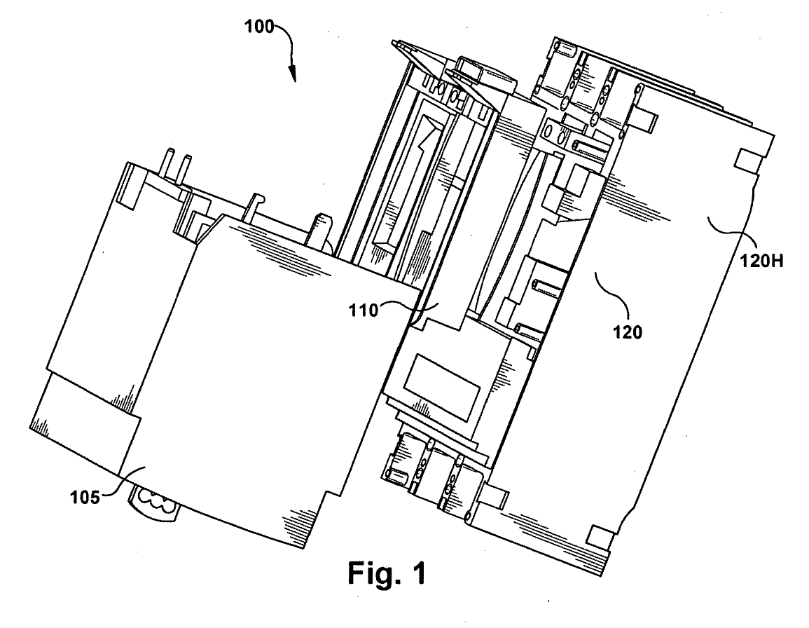

In one exemplary embodiment, referring to FIG. 1 a circuit breaker 120 and an accessory device 100 arrangement is provided. Although the embodiments disclosed will be described with reference to the drawings, it should be understood that the embodiments disclosed may be embodied in many alternate forms. In addition, any suitable size, shape or type of elements or materials may be used.

The exemplary embodiments may provide a reliable arrangement of mounting an accessory device 100 to a circuit breaker 120 in such a way that the accessory device 100 and circuit breaker 120 work in tandem to attenuate or reduce any mechanical shock or force generated by the circuit breaker accessory device. The mounting arrangement operates to avoid transferring the mechanical shock or force to other portions of the circuit breaker 120 or other portions of the accessory device 100. In one aspect, the exemplary embodiments may advantageously avoid malfunctions in an electrical system or disruption of a power supply of the electrical system due to inadvertent tripping of peripheral circuit breaker devices due to mechanical shock or force generated by the accessory device 100.

In one exemplary embodiment, the accessory device 100 may be a motor operator that allows for the remote operation of the circuit breaker 120. However, in alternate embodiments, the exemplary embodiments may be equally applied to any suitable circuit breaker accessory device.

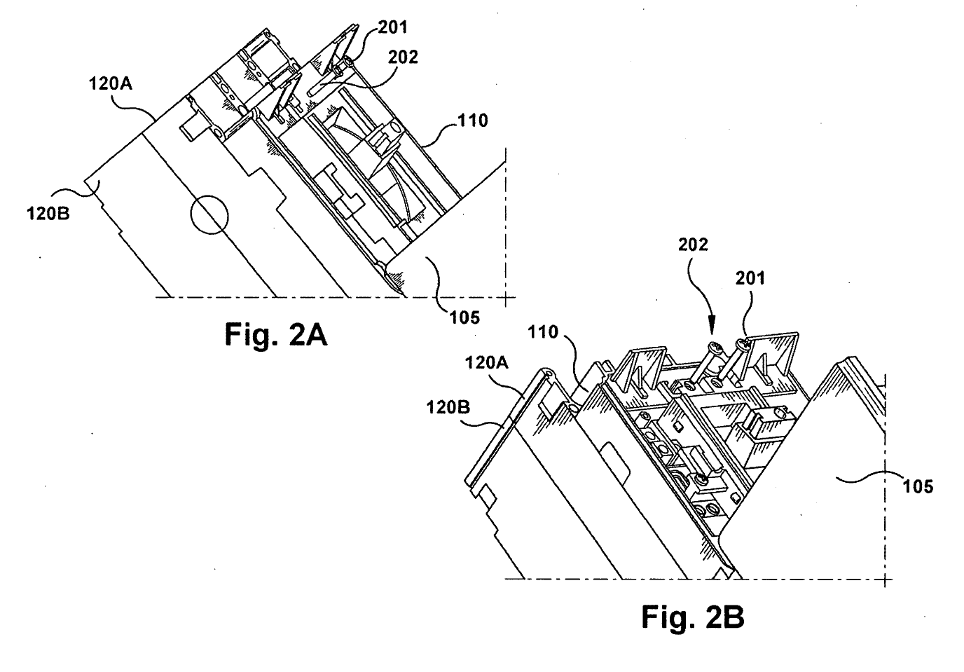

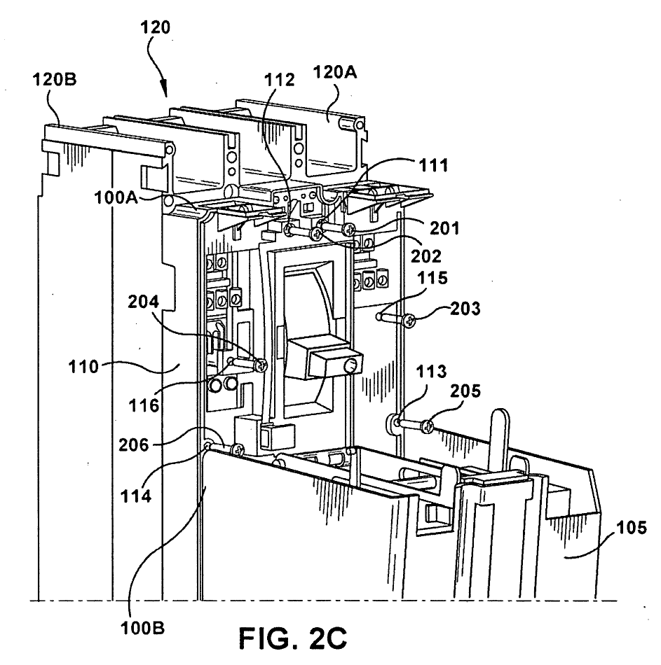

Still referring to FIG. 1 and also to FIGS. 2A-2C the accessory device 100 includes a base plate 110 and an accessory device top portion 105 that may be affixed to the base plate 110 in any suitable manner, such as by a hinged connection. The circuit breaker 120 includes an insulated circuit breaker housing 120H, which in one example, has a top portion 120A, and a lower portion 120B, each configured to house respective components of the circuit breaker 120. In alternate embodiments the accessory device 100 and circuit breaker 120 may have any suitable configuration.

The base plate 110 of the circuit breaker accessory device may be rigidly mounted to the top portion 120A of the circuit breaker 120 in any suitable manner. In one exemplary embodiment, the base plate 110 may be mounted to the top portion 120A by, for example, any suitable number of fasteners 201-206, such as screws.

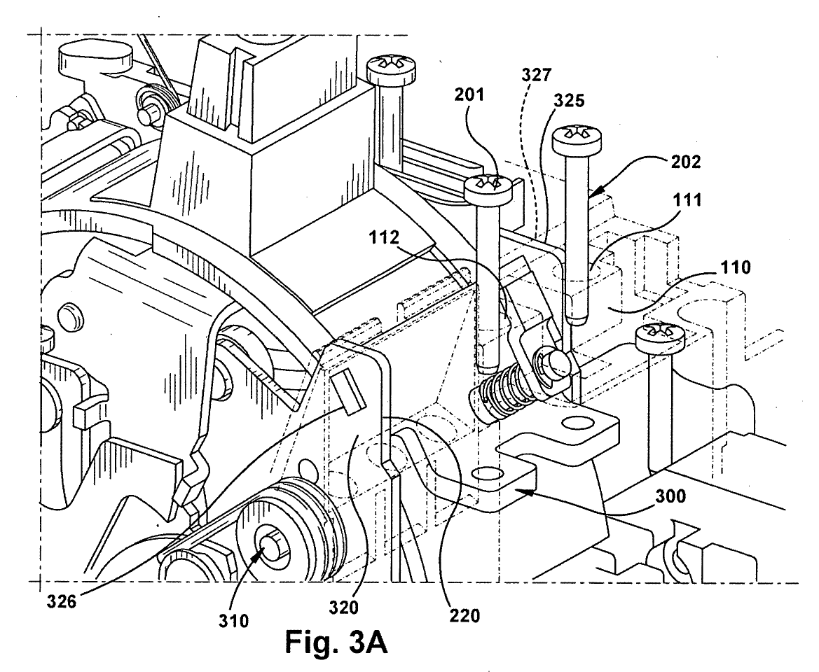

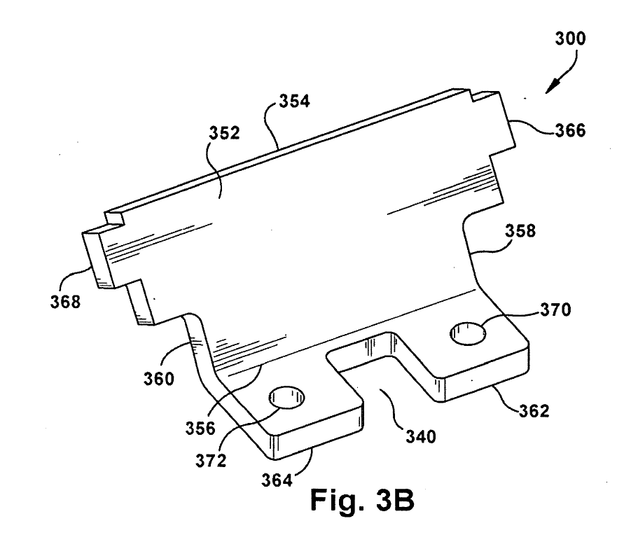

In another exemplary embodiment one or more first fasteners 201, 202 may retain the accessory base plate 110 and engage an apparatus 300 in the form of a breaker mechanism plate (FIGS. 3A, 3B) mounted at a first end 220 (FIG. 3A) of the circuit breaker 120 as will be described in greater detail below. One or more second fasteners 205, 206 (FIG. 2C) may be located at a second end of the circuit breaker opposite the first end. Fasteners 205, 206 may retain and align the accessory base plate 110 to the circuit breaker top portion 120A and may engage the circuit breaker 120, for example at the top portion 120A to affix the accessory device 100 to the circuit breaker 120. One or more third fasteners 203, 204 (FIG. 2C) may be located in between the first and second ends and thus in between the fasteners 201, 202 and 205, 206. Fasteners 203, 204 may retain the accessory device 100 and engage the circuit breaker 120, for example at the circuit breaker top portion 120A to also affix the accessory device 100 to the circuit breaker 120. While the one or more first, second, and third fasteners are each shown as two fasteners, it should be understood that they may include any number of one or more fasteners.

Referring to FIG. 3A, the mounting of the apparatus 300 to the first end 220 of the circuit breaker 120 and the fixation of the accessory base plate 110 to the apparatus 300 is shown in greater detail. In this example, the circuit breaker 120 includes an operating mechanism 310 at least partially located or housed within the circuit breaker top portion 120A. Operating mechanism 310 includes side frames 320, 325, which are generally parallel to each other as mounted within the operating mechanism 310. Each side frame 320, 325 includes a respective opening 326, 327. The apparatus 300, also referred to as the breaker mechanism plate may be secured to the side frames 320, 325 through the openings 326, 327.

Referring also to FIG. 3B, the apparatus 300 is shown in greater detail. For exemplary purposes only, the apparatus, or breaker mechanism plate 300 includes a base 352 having a first edge 354, second edge 356, third edge 358 and fourth edge 360. Third edge 358 and fourth edge 360 are positioned between first and second edges 354, 356. Integral with the base 352 are one or more legs, in this exemplary embodiment, two legs 362, 364 projecting outward from the base 352 along the second edge 356. In one example, the base 352 is angled relative to the legs 362, 364 and the legs 362, 364 project outward from the base 352 in a side-by-side relation. The legs 362, 364 are generally adjacent to each other in the same plane and may be separated by a cutout 340. Legs 362, 372 also include one or more apertures 370, 372. Extending outward from third edge 358 is a projection 366. Other embodiments may include additional projections. For example, in this embodiment projection 368 extends outward from fourth edge 360. In at least one embodiment projections 366 and 368 may extend in opposite directions. As shown in the exemplary embodiment of FIG. 3A, projection 366 may engage opening 325 of side frame 320 and projection 368 may engage opening 326 of side frame 320 to rigidly secure the apparatus 300, also referred to as the breaker mechanism plate to circuit breaker 120.

The mounting and securement of the accessory device 100 to the circuit breaker 120 (FIG. 1) will now be described with respect to FIGS. 3A, 3B and 2C. When the accessory device 100 is placed on the circuit breaker top portion 120A at least one of the fasteners 201, 202 pass through at least one of respective apertures 111, 112 at a first end 100A of the accessory base plate 110 and into at least one of respective apertures 370, 372 of the apparatus 300, also referred to as the breaker mechanism plate. The apertures 370, 372 may be suitably configured to engage the fasteners 201, 202. In one example, the apertures 370, 372 may be threaded apertures configured to mate with threads of the fasteners 201, 202. In alternate embodiments, the fasteners 201, 202 and the apparatus 300 may be configured to form a rigid connection between the accessory base plate 110 and the apparatus 300 in any suitable manner.

The connection formed between the accessory base plate 110 and the apparatus 300 is such that any mechanical shock or mechanical force generated by the operation of accessory device 100 is substantially reduced or attenuated upon generation of the mechanical shock or mechanical force by the accessory device 100. In this exemplary embodiment, the coupling formed between the accessory base plate 110 and the apparatus 300 is such that the accessory device 110 and the circuit breaker 120 work in tandem to reduce or attenuate any mechanical shock or force generated by, for example, the accessory device to a minimum level. In addition, the mounting arrangement operates to “ground” the mechanical shock or force in order to minimize any transfer of the mechanical shock or force to other portions of the circuit breaker 120 or other portions of the accessory device 100. Reducing or minimizing the mechanical shock or force may generally avoid a malfunction in any electrical system protected by circuit breaker 120 or disruption of a power supply in the protected electrical system due to inadvertent tripping of the peripheral devices due to the mechanical shock or force acting on the circuit breaker 120 or any peripheral accessories of the circuit breaker.

At least one of the second set of fasteners 205, 206 (FIG. 2C) located at a second end 100B of the accessory base plate 110 opposite the first end 100A may be inserted through at least one of the respective apertures 113, 114 of the accessory base plate 110 for retaining and aligning the accessory device 100 to the circuit breaker 120 and for affixing the accessory base plate 110 to the circuit breaker 120. At least one of a third set of fasteners 203, 204 may be inserted through respective apertures 115, 116 for affixing the accessory base plate 110 to the circuit breaker 120. It is noted that the insertion of the fasteners 201-206 may occur in any suitable order for affixing the accessory device 100 to the circuit breaker 120.

While exemplary embodiments have been described in connection with what are presently considered to be the most practical and preferred embodiments, it is to be understood that the embodiments are not limited to those disclosed herein. Rather, the embodiments described are intended to cover all of the various modifications and equivalent arrangements included within the spirit and scope of the appended claims.

What is claimed is:

1. An apparatus for connecting an accessory device to a circuit breaker to attenuate mechanical force generated by the accessory device, the apparatus comprising:
a base having one or more projections configured to engage the circuit breaker to form a rigid connection to the circuit breaker; and
one or more apertures configured for engagement with the accessory device to form a rigid connection to the accessory device.

2. The apparatus of claim 1, wherein the one or more projections include at least two projections extending in opposite directions.

3. The apparatus of claim 1, wherein the one or more projections are configured to engage openings in side frames of the circuit breaker.

4. The apparatus of claim 1, comprising one or more legs in which the one or more apertures are positioned.

5. The apparatus of claim 1, wherein the one or more apertures are threaded.

6. An assembly for connecting an accessory device to a circuit breaker, the assembly comprising:
an accessory base plate; and
an apparatus including:
a base having one or more projections configured to engage the circuit breaker to form a rigid connection to the circuit breaker; and
one or more apertures configured for engagement with the accessory base plate to form a rigid connection to the accessory base plate.

7. The assembly of claim 6, wherein the rigid connections to the circuit breaker and the accessory base plate operate to attenuate mechanical force generated by the accessory device.

8. The assembly of claim 6, wherein the one or more apertures are located at a first end of the accessory base plate.

9. The assembly of claim 6, further comprising a first fastener configured to retain the accessory base plate and engage one of the one or more apertures.

10. The assembly of claim 6, further comprising a second fastener located at a second end of the accessory base plate, the second fastener configured to affix and align the accessory base plate to the circuit breaker.

11. The assembly of claim 6, further comprising a third fastener located between a first and second end of the accessory base plate, the third fastener configured to affix the accessory base plate to the circuit breaker.

12. A circuit breaker assembly comprising:
a circuit breaker;
an accessory device; and
an apparatus including:
a base having one or more projections configured to engage the circuit breaker to form a rigid connection to the circuit breaker; and
one or more apertures configured for engagement with the accessory device to form a rigid connection to the accessory device.

13. The circuit breaker assembly of claim 12, wherein the rigid connections to the circuit breaker and the accessory device operate to attenuate mechanical force generated by the accessory device.

14. The circuit breaker assembly of claim 12, wherein the one or more apertures are located at a first end of the accessory base plate.

15. The circuit breaker assembly of claim 14, further comprising a first fastener configured to retain the accessory base plate and engage one of the one or more apertures.

16. The circuit breaker assembly of claim 12, further comprising a second fastener located at a second end of the accessory base plate, the second fastener configured to affix and align the accessory base plate to the circuit breaker.

17. The circuit breaker assembly of claim 12, further comprising a third fastener located between a first and second end of the accessory base plate, the third fastener configured to affix the accessory base plate to the circuit breaker.

18. The circuit breaker assembly of claim 12, wherein the one or more projections of the apparatus are configured to engage openings in side frames of the circuit breaker.

19. The circuit breaker assembly of claim 12, wherein the circuit breaker accessory device comprises a motor operator.

20. A method for attenuating mechanical force induced in a circuit breaker by an accessory device, comprising:
engaging the circuit breaker with an apparatus to form a rigid connection to the circuit breaker; and
engaging the accessory device with the apparatus to form a rigid connection to the accessory device,
wherein the rigid connections to the circuit breaker and the accessory device operate to attenuate mechanical force generated by the accessory device.

21. The method of claim 20, further comprising engaging openings in side frames of the circuit breaker with the apparatus.

22. The method of claim 20, further comprising engaging fasteners retaining the accessory device with the apparatus.
